(19) United States
(12) Patent Application Publication
(10) Pub. No.: US 2020/0286187 A1
(43) Pub. Date: Sep. 10, 2020

(54) CONTRIBUTION RATE DETERMINATION FOR NETWORK-CONNECTED DEVICES

(71) Applicant: Wells Fargo Bank, N.A., San Francisco, CA (US)

(72) Inventors: Muhammad Farukh Munir, Pittsburg, CA (US); James D. Cahill, Belmont, MA (US); Derick McGee, San Francisco, CA (US)

(21) Appl. No.: 15/213,050

(22) Filed: Jul. 18, 2016

(51) Int. Cl. G06Q 50/06; G06Q 40/00

(52) U.S. Cl. CPC G06Q 50/06; G05B 2219/2642; G06Q 40/12

(57) ABSTRACT

In an example, a computer-implemented method includes associating a network-connected device of a user with a financial account of the user, the financial account being provided by a financial services provider. The method also includes determining one or more cost factors associated with the network-connected device, at least one of the one or more cost factors being based on cost data that is sourced from a plurality of second network-connected devices that are comparable to the network-connected device and indicative of maintenance costs associated with the plurality of second network-connected devices. The method also includes determining a rate of contribution for the financial account based on the one or more cost factors associated with the device, and outputting the rate of contribution.

### TECHNICAL FIELD

The invention relates to networked devices.

### BACKGROUND

Many home appliances, such as thermostats, refrigerators, washing machines, ovens, toasters, lights, sprinkler systems, or other devices are able to connect to a network such as the Internet. Such network-connected devices may be referred to as “smart” devices or “Internet of Things” devices. In some cases, the network-connected devices may provide data to appliance manufacturers or other third parties, including data related to the use and operation of the devices and connectivity with other devices.

### SUMMARY

The techniques of this disclosure include using electronic data sourced from network-connected devices (which may be referred to herein as simply “connected devices”) to manage one or more financial accounts. For example, according to aspects of this disclosure, a computing device of a financial services provider may associate a financial account of a user with a connected device of the user. The computing device may access data related to the use and operation of the connected device or other comparable devices, e.g., from a manufacturer of the connected device or another third-party. The computing device may use the data to determine one or more cost factors associated with ownership of the connected device. For example, if the data indicates that a particular component of the connected device is prone to failure, the computing device may account for this failure in the cost of ownership of the connected device. The computing device may determine a rate of contribution for the associated financial account based on the cost factors. In this way, aspects of this disclosure relate to providing efficient savings techniques for repairing or replacing a connected device based on electronically sourced data from a plurality of the same or comparable devices.

In an example, a computer-implemented method includes associating a network-connected device of a user with a financial account of the user, the financial account being provided by a financial services provider. The method also includes determining one or more cost factors associated with the network-connected device, at least one of the one or more cost factors being based on cost data that is sourced from a plurality of second network-connected devices that are comparable to the network-connected device and indicative of maintenance costs associated with the plurality of second network-connected devices. The method also includes determining a rate of contribution for the financial account based on the one or more cost factors associated with the device, and outputting the rate of contribution.

In another example, a non-transitory computer-readable medium has instructions stored thereon that, when executed, cause one or more processors to associate a network-connected device of a user with a financial account of the user, the financial account being provided by a financial services provider, determine one or more cost factors associated with the network-connected device, at least one of the one or more cost factors being based on cost data that is sourced from a plurality of second network-connected devices that are comparable to the network-connected device and that is indicative of maintenance costs of the plurality of second network-connected devices, determine a rate of contribution for the financial account based on the one or more cost factors associated with the device, and output the rate of contribution.

In another example, a device comprises a memory configured to store data associated with a financial account of a user, and one or more processors in communication with the memory. The one or more processors are configured to associate a network-connected device of a user with the financial account of the user, determine one or more cost factors associated with the network-connected device, at least one of the one or more cost factors being based on cost data that is sourced from a plurality of second network-connected devices that are comparable to the network-connected device and that is indicative of maintenance costs of the plurality of second network-connected devices, determine a rate of contribution for the financial account based on the one or more cost factors associated with the device, and output the rate of contribution.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example computing system having a device financing unit for providing efficient savings techniques for repair or replacement of a connected device, in accordance with the techniques of this disclosure.

FIG. 2 is a block diagram illustrating the computing system of FIG. 1 in greater detail.

FIG. 3 is a conceptual diagram of a system for identifying a plurality of connected devices that are connected to a home network, in accordance with the techniques of this disclosure.

FIG. 4 is a flow diagram illustrating an example process for saving for repair or replacement of a connected device, in accordance with the techniques of this disclosure.

### DETAILED DESCRIPTION

Aspects of this disclosure relate to providing efficient savings techniques for repair or replacement of a network-connected device based on electronically sourced data from a plurality of the same or comparable devices. A network-connected device (interchangeably referred to herein as a “connected device”) may include a wide variety of appliances (e.g., thermostats, refrigerators, microwaves, washing machines, dryers, ovens, toasters, lights, sprinkler systems, or the like) or other devices capable of connecting to a network (e.g., such as the Internet) and communicating data regarding the operation, malfunction, location, or other data about the device. Such connected devices may be referred to as “Smart” devices/appliances or “Internet of Things” devices/appliances. The same device may refer to a device having the same make and model as the connected device. A comparable device may refer to a device having one or more commonalities with the connected device, such as the same manufacturer, the same or similar components, or the like.

According to aspects of this disclosure, a financial account may be associated with one or more connected devices to offset or pay for maintenance, repairs and/or replacement of the connected devices. For example, when a consumer (or “user”) purchases a new connected device, the connected device is linked to a device maintenance, repair, and/or replacement account for the consumer at a financial services provider. In some examples, the financial account may include a plurality of sub-accounts, with each respective sub-account assigned to each linked connected device.

In the example above, an automatic contribution to the financial account(s) may be determined. The rate of contribution (or “rate of savings”) may be a function of several factors including, as examples, data from the consumer's connected devices, data from comparable connected devices, the real-time price of repairs or maintenance for the connected devices, the real-time price of replacement of the connected devices, or the like. The consumer's current financial health may also be a factor in determining the rate of contribution. The rate of contribution may be established as a particular monetary value per measure of time (e.g., a particular dollar amount on a weekly, bi-weekly, monthly, yearly, or other basis).

In an example for purposes of illustration, when a connected device is new, the rate of contribution to the financial account may be relatively low, since short term maintenance, repairs and replacement are unlikely. As data from the consumer's appliance and other comparable appliances indicate upcoming needs for maintenance, repair or replacement, the rate of contribution may increase. In this way, the balance of the financial account may build based on an expected date of need (e.g., based on an expected date of malfunction/failure). Saving for general maintenance, malfunction or failure of the connected device on a period basis, using the techniques described herein, may be more financially agreeable to the user than having to pay for an expenditure associated with the connected device without such savings. According to aspects of this disclosure, the expected date of failure may change in real-time as a function of repair/replacement times for comparable devices with other consumers. Also, the expected cost to the consumer may be based on real-time analysis of similar repair or replacement costs. The techniques may also include altering the rate of contribution based on the consumer's financial health, e.g., changes in cash flow to other accounts maintained by the financial services provider.

In this way, the techniques of this disclosure may include linking a consumer's connected device to a financial account of a financial services provider, monitoring data from the consumer's connected device and comparable devices of other consumers, determining real-time costs of maintenance/repair/replacement for the consumer's connected device based on current prices and past repair costs to the same or comparable connected devices, analyzing consumer and comparable connected device data and real-time costs to determine an estimated timing and cost for maintenance/repair/replacement of the connected device, and setting a rate of contribution to the financial account based on the analysis.

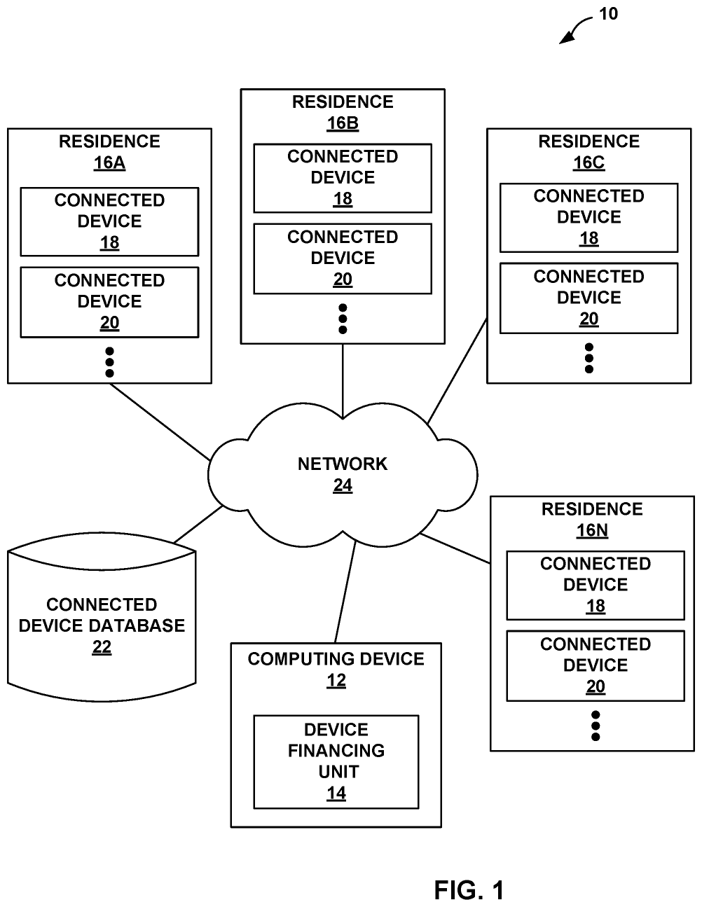

FIG. 1 is a block diagram illustrating an example computing system having a device financing unit for providing efficient savings techniques for maintenance, repair or replacement of a connected device, in accordance with the techniques of this disclosure. The example computing system 10 of FIG. 1 includes a computing device 12 having a device financing unit 14. Computing system 10 also includes residences 16A-16N (collectively “residences 16”) each having a respective connected device 18 and connected device 20 and connected device database 22. The components of computing system 10 may be connected via network 24.

Computing device 12 may include a variety of devices for processing and/or manipulating data. For example, in general, the functionality of computing device 12 may be implemented in a device that includes one or more processing units, such as one or more microprocessors. The functionality of computing device 12 may be implemented in hardware or in a combination of software and hardware, where requisite hardware may be provided to store and execute software instructions. Such hardware may include, for example, a processing unit and a computer-readable storage medium. Other hardware may include digital signal processors (DSPs), application specific integrated circuits (ASICs), field programmable gate arrays (FPGAs), or any other equivalent integrated or discrete logic circuitry, as well as any combinations of such components.

While shown as a single computing device in the example of FIG. 1 for purposes of illustration, in some examples, computing device 12 may include a distributed network of computing devices including one or more databases, file servers, and/or other computing devices. In addition, computing device 12 may include one or more other components for carrying out the techniques described herein, such as one or more other processors, storage units, interfaces to communicate with external devices, input/output devices, or the like.

As described in greater detail below, device financing unit 14 may be responsible for providing efficient savings techniques for maintenance, repair or replacement of a connected device, such as connected device 18 and/or connected device 20. Device financing unit 14 may include instructions executed by one or more processors of computing device 12 to perform the functions of device financing unit 14. In some examples, computing device 12 and device financing unit 14 may be associated with a financial services provider that offers different banking products, such as checking accounts, savings accounts, and credit accounts; and/or different lending products, such as home loans, car loans, business loans, student loans, and the like. While a financial services provider may take the form of a traditional bank, in other examples, the financial services provider may be associated with an electronic currency or another non-traditional financial service.

Residences 16 may each be associated with a consumer (also referred to herein as a user) and one or more connected devices such as connected device 18 and/or connected device 20. In some examples, connected device 18 and connected device 20 may form a part of a local area network (LAN) or wireless local area network (WLAN) of respective residences 16. Connected device 18 of each of residences 16 may be the same or a comparable connected device, such as any variety of appliances (e.g., thermostats, refrigerators, microwaves, washing machines, dryers, ovens, toasters, lights, sprinkler systems, or the like) or other devices. Likewise, connected device 20 of each of residences 16 may be the same or a comparable connected device.

A “connected device,” such as connected device 18 or connected device 20, may refer to any electronic device capable of connecting to network 24 and communicating data regarding the operation, malfunction, location or other data about the device. As noted above, such connected devices may be referred to as “Smart” devices or “Internet of Things” devices. While such connected devices may typically communicate via the Internet, in other examples, connected device 18 and connected device 20 may communicate via any suitable network, such as network 24. Accordingly, “connected device” and “Internet-connected device” may refer to any device capable of transmitting data to (or receiving data from) another networked device and be used interchangeably herein.

In some instances, a user may control connected device 18 and/or connected device 20 remotely, e.g., via an electronic device of the user connected to network 24. In other examples, connected device 18 and connected device 20 may each include at least one user interface device (not shown) that enables a user to interact with the connected device. In some examples, the user interface devices may be configured to receive tactile, audio, or visual input and may be configured to output content such as graphical user interfaces (GUIs) for display to the users, e.g., at display devices associated with connected device 18 or connected device 20. While the example shown in FIG. 1 illustrates each of residences 16 having two connected devices (i.e., connected device 18 and connected device 20), it should be understood that other examples may include more or fewer connected devices than those shown.

Connected device database 22 may store data sourced from connected devices, such as connected device 18 or connected device 20. For example, connected device database 22 may store any variety of data associated with the operation, malfunction, location or other information about a connected device. To the extent that the stored data is useful for determining a cost of maintenance, a repair and/or replacement of a connected device, such stored data may be referred to as cost data (as described in greater detail herein).

While the example of FIG. 1 illustrates connected device database 22 as a single database, it should be understood that connected device database 22 may be distributed among a number of databases or other storage devices. For example, each manufacturer of a connected device may maintain a separate connected device database 22 that contains data separated by a model (or serial number/other identifier) or a group of comparable models. In other examples, a third-party other than the manufacturer may maintain one or more databases of data, such as connected device database 22. In still other examples, the entity associated with computing device 12 (such as a financial service provider) may maintain one or more databases of data, such as connected device database 22.

Network 24 may comprise a private network that includes, for example, a private network associated with a financial services provider, or may comprise a public network, such as the Internet. Although illustrated as a single entity, network 24 may comprise any combination of public and/or private telecommunications networks, and any combination of computer or data networks and wired or wireless telephone networks. In some examples, network 24 may comprise one or more of a wide area network (WAN) (e.g., the Internet), a virtual private network (VPN), a LAN, a WLAN (e.g., a Wi-Fi network), a wireless personal area network (WPAN) (e.g., a Bluetooth® network), or the public switched telephone network (PTSN).

In some instances, a user of a connected device, such as connected device 18 or connected device 20, may not adequately plan for expenses associated with maintaining or replacing the connected device. In such instances, it may be difficult for a user to fully fund a repair or replacement of the connected device when a malfunction occurs or replacement of components associated with general maintenance. In addition, a user may not have access to electronic data regarding the operation, malfunction, or replacement of comparable connected devices.

The techniques of this disclosure may provide a computer-implemented manner in which to efficiently save for maintenance, repair or replacement of a connected device. In an example for purposes of illustration, device financing unit 14 may associate connected device 18 of residence 16A with a financial account of the user and that is maintained by computing device 12. Device financing unit 14 may also determine one or more cost factors associated with connected device 18. Device financing unit 14 may determine a rate of contribution for the financial account based on the one or more cost factors associated with connected device 18 and output the rate of contribution.

According to aspects of this disclosure, at least one of the cost factors may be based on cost data that is sourced from a plurality of second connected devices that are comparable to the connected device, such as connected device 18 of residence 16B, connected device 18 of residence 16C, and connected device 18 of residence 16N. As noted above, the cost data may be indicative of maintenance and/or repair costs of the plurality of second connected devices. Other cost factors may include, as examples, an initial purchase price of connected device 18 or an estimated replacement cost of connected device 18. Another cost factor may be the geographical location in which connected device 18 located, which may impact the availability and/or costs associated with servicing connected device 18.

As noted above, device financing unit 14 may determine a rate of contribution for the financial account based on the one or more cost factors. For example, device financing unit 14 may determine one or more maintenance events associated with other connected devices 18 (the same or comparable connected devices 18). For instance, device financing unit 14 may determine that a particular component of the other connected devices 18 fails at some point during the life of the other connected devices 18 and requires maintenance to repair. Device financing unit 14 may determine a rate of contribution that is sufficient to satisfy the costs associated with the one or more maintenance events.

In some examples, device financing unit 14 may determine a rate of contribution that is static over time. In other examples, device financing unit 14 may determine a rate of contribution that varies over time. For example, device financing unit 14 may determine a rate of contribution that is relatively low when connected device 18 is new and increase the rate of contribution throughout the lifetime of connected device 18, e.g., as general maintenance, repairs or replacement become more likely.

According to aspects of this disclosure, device financing unit 14 may determine the rate of contribution a single time or on a periodic basis. For example, device financing unit 14 may determine a rate of contribution for an estimated life of connected device 18 at the time of associating connected device 18 with the financial account. In some examples, device financing unit 14 may also periodically determine (e.g., update) the rate of contribution one or more times over the lifetime of connected device 18. For example, cost data from comparable connected devices 18 may be added to connected device database 22 in real-time or near real-time during operation of connected devices 18. Device financing unit 14 may receive or access the cost data from connected device database 22 on a periodic basis and update the rate of contribution based on the newly available data. In this manner, device financing unit 14 may determine the rate of contribution based on up-to-date data from the same or comparable devices.

Device financing unit 14 may output the rate of contribution. For example, device financing unit 14 may generate an electronic message to the user that indicates the rate of contribution. In another example, device financing unit 14 may automatically transfer funds to the financial account associated with the connect device 18 at the rate of contribution from another account of the user and maintained by computing device 12. In this way, the techniques provide a computer-implemented manner in which to efficiently save for maintenance, repair or replacement of connected device 18. While the example described above is described with respect to connected device 18 of residence 16A, it should be understood that the techniques are equally applicable to a variety of other connected devices.

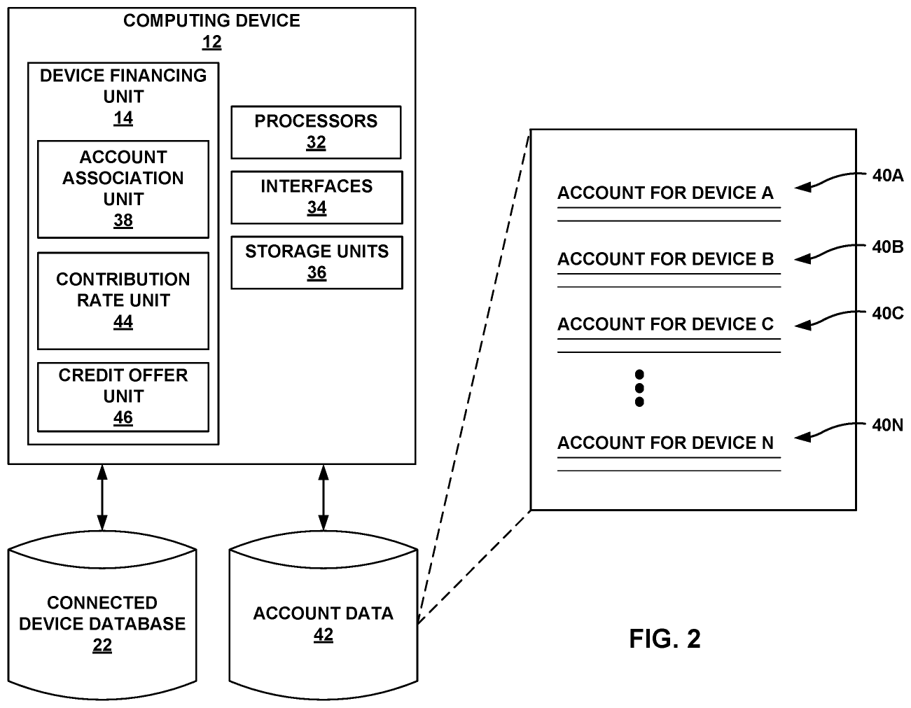

FIG. 2 is a block diagram illustrating several components of computing system 10 in greater detail. For example, computing device 12 includes device financing unit 14, one or more processors 32, one or more interfaces 34, and one or more storage units 36. In the example shown in FIG. 2, device financing unit 14 includes account association unit 38 that is responsible for generating accounts 40A-40N (collectively, accounts 40) stored as account data 42, contribution rate unit 44, and credit offer unit 46.

The architecture of computing device 12 (and, more broadly, computing system 10) illustrated in FIG. 2 is shown for exemplary purposes only. In other examples, computing system 10 and computing device 12 may be configured in a variety of other ways having additional, fewer, or alternative components than those shown in FIG. 2. For example, while computing device 12 is illustrated in the example of FIG. 2 as a single computing device, in other examples computing device 12 may have multiple components, e.g., in a distributed computing environment.

Processors 32, in one example, are configured to implement functionality and/or process instructions for execution within computing device 12. For example, processors 32 may be capable of processing instructions stored by storage units 36. Processors 32 may include, for example, microprocessors, digital signal processors (DSPs), application specific integrated circuits (ASICs), field-programmable gate array (FPGAs), or equivalent discrete or integrated logic circuitry.

Computing device 12 may utilize interfaces 34 to communicate with external devices via one or more wired or wireless connections. In some examples, computing device 12 utilizes interfaces 34 to communicate with external devices. Interfaces 34 may be network interfaces cards, universal serial bus (USB) interfaces, optical interfaces, or any other type of interfaces capable of sending and receiving information via TCP/IP. Examples of such network interfaces may include Ethernet, Wi-Fi, or Bluetooth radios.

Storage units 36 may store an operating system (not shown) that controls the operation of components of computing device 12. For example, the operating system may facilitate the communication of dependency determination unit 14 with processors 32, interfaces 34, and storage units 36. In some examples, storage units 36 are used to store program instructions for execution by processors 32. Storage units 36 may also be configured to store information within computing device 12 during operation. Storage units 36 may be used by software or applications (e.g., dependency determination unit 14) running on processors 32 of computing device 12 to temporarily store information during program execution.

Storage units 36 may include a computer-readable storage medium or computer-readable storage device. In some examples, storage units 36 include one or more of a short-term memory or a long-term memory. Storage units 36 may include, for example, random access memories (RAM), dynamic random access memories (DRAM), static random access memories (SRAM), magnetic hard discs, optical discs, flash memories, or forms of electrically programmable memories (EPROM) or electrically erasable and programmable memories (EEPROM).

According to aspects of this disclosure, as noted above with respect to FIG. 1, device financing unit 14 may be configured to enable efficient savings for maintenance, repair or replacement of a connected device, such as connected device 18 or connected device 20 (FIG. 1), or any other connected device.

According to aspects of this disclosure, account association unit 38 may associate a connected device with one of financial accounts 40. In some examples, in order to associate the connected device with one of financial accounts 40, account association unit 38 may be responsible for generating financial accounts 40.

In one example, account association unit 38 may identify the purchase of a connected device and automatically generate one of financial accounts 40 based on the identification of the purchase. For example, account association unit 38 may access account data 42, which may include financial data associated with one or more pre-existing financial accounts of a user of the connected device. The financial data may include, as examples, transaction data associated with a checking account, check card, credit card, or the like. In this example, account association unit 38 may generate one of financial accounts 40 based on an identification of a purchase of the connected device in the financial data.

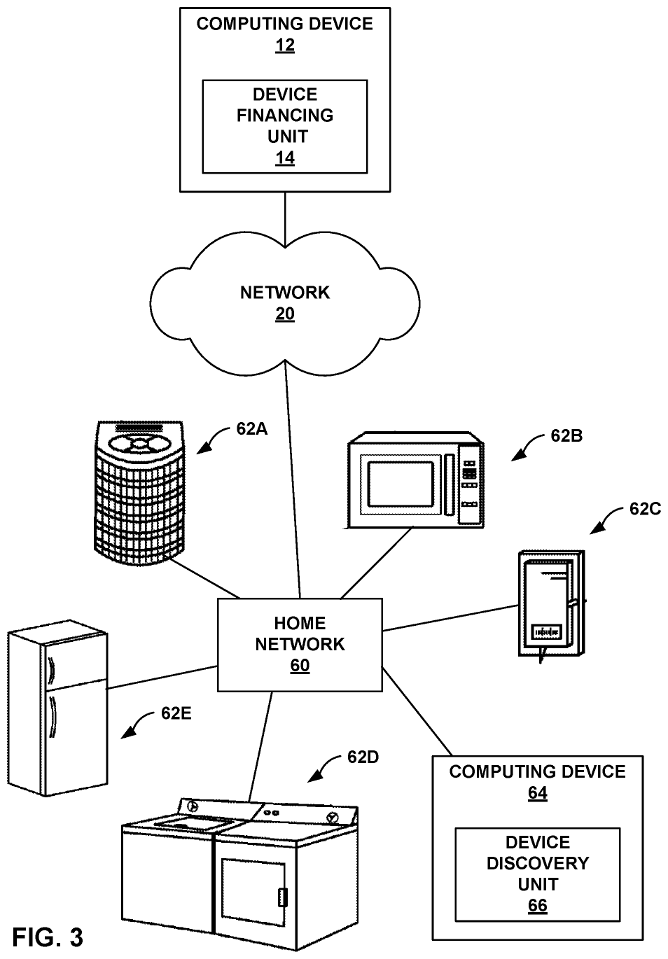

In another example, account association unit 38 may identify a connected device via an electronic application or other interface of a financial services provider upon connection of the connected device to a home network of the user. Aspects of this example are described in greater detail below with respect to the example of FIG. 3. In one example, the financial services provider may connect to a home network of the user and may monitor the home network for connected devices. Account association unit 38 may identify any new connected devices upon connection to the home network. Account association unit 38 may then generate and associate one of financial accounts 40 for a new connected device.

In still another example, a user of a connected device may manually input information that identifies the connected device and account association unit 38 may generate one of financial accounts 40. For instance, the user may provide a make and model, serial number, or other identifying information of the connected to account association unit 38 via an electronic device (e.g., such as a smartphone or other computing device of the user). Account association unit 38 may then generate and associate one of financial accounts 40 for the connected device.

In some examples, account association unit 38 may transmit an electronic offer to generate one of financial accounts 40 to an electronic device associated with the user. For example, account association unit 38 may generate a text message, email message, or an electronic message of a mobile banking application with an offer to generate one of financial accounts upon identification of a connected device. For example, as described above, account association unit 38 may identify a purchase of a connected device based on financial data and may subsequently generate an electronic offer to establish one of financial accounts 40 for the connected device. In another example, account association unit 38 may generate an electronic offer to establish one of financial accounts 40 based on identification of a connected device via a web application or other interface maintained by the financial services provider associated with financial accounts 40.

Account association unit 38 may, in some instances, generate an incentive for the user to establish one of financial accounts 40 for a connected device. For example, account association unit 38 may identify a connected device (as described above) and may generate a financial incentive for the user to establish one of financial accounts 40, such as a one-time monetary reward for establishing one of financial accounts 40.

According to aspects of this disclosure, account association unit 38 may generate financial accounts 40 as sub-accounts of a preexisting financial account maintained by computing device 12. For example, a user may have a pre-established checking or savings account with a financial services provider. In this example, account association unit 38 may generate respective financial accounts 40 for each connected device as sub-accounts of the pre-established checking or savings account.

Contribution rate unit 44 may determine one or more cost factors associated with a connected device and determine a contribution rate to one of financial accounts 40 for the connected device based on the one or more cost factors. According to aspects of this disclosure, as described above, at least one of the cost factors may be based on cost data that is sourced from a plurality of second connected devices that are the same as or comparable to the connected device. In the example of FIG. 2, contribution rate unit 44 may retrieve the cost data from connected device database 22.

The cost data may be indicative of maintenance and/or replacement costs of the plurality of second connected devices. For example, cost data stored to connected device database 22 may identify components of connected devices that have failed and/or the costs associated with repairing or replacing the failed components. In an example for purposes of illustration, a compressor of a particular make and model of smart refrigerator may be prone to failure as indicated by data provided by connected devices of the particular make and model. The cost data stored to connected device database 22 may indicate a cost associated with repairing or replacing the compressor.

In some examples, the cost data may be time indexed based on an estimated malfunction or failure time. For example, continuing with the compressor example above, the cost data may indicate that compressor is prone to failure three years after the initial operation of the smart refrigerator. In another example, the cost data may indicate that an electrical system of the smart refrigerator is prone to failure four years after the initial operation of the smart refrigerator. In these examples, cost data stored to connected device database 22 may include an indication of a timing of the anticipated cost of repair or replacement. Cost data may be updated in real-time or near real-time. For example, connected devices may continually transmit data associated with the operation of the connected devices to connected device database 22.

According to aspects of this disclosure, contribution rate unit 44 may also consider one or more other cost factors when determining a contribution rate for one of financial accounts 40. For example, contribution rate unit 44 may determine an initial purchase price of a connected device. Contribution rate unit 44 may adjust the initial purchase price for inflation to determine an estimated replacement cost of the connected device and use the estimated replacement cost as a cost factor. In some examples, contribution rate unit 44 may also adjust the estimated replacement cost of a connected device based on financial data of the user. For example, if account balances of the user indicate an improving financial status of the user, the user may be more inclined to purchase a more expensive replacement device. In this example, contribution rate unit 44 may adjust the estimated replacement cost accordingly.

In some examples, contribution rate unit 44 may additionally or alternatively determine a geographical cost factor. For example, the geographical location in which a connected device is located may impact costs of repair due to the availability of technicians to repair the connected device or the cost of technicians to repair the connected device. For example, a technician in a major metropolitan area may be costlier per hour than a technician in a rural area. In another example, a technician for a particular make or model of connected device may not be available in a particular geographical area, thereby making a repair of the connected device costlier.

In some examples, contribution rate unit 44 may additionally or alternatively determine a financial status cost factor. For example, contribution rate unit 44 may access financial data associated with pre-existing financial accounts of a user. Contribution rate unit 44 may identify changes in the balances of the pre-existing accounts of the user and determine a financial status cost factor based on the balances. For example, when the balances of the pre-existing accounts rise, contribution rate unit 44 may determine that the user is able to contribute to one of financial accounts 40 at a relatively higher rate.

Contribution rate unit 44 may determine a rate of contribution for one of financial accounts 40 based on the one or more cost factors. For example, contribution rate unit 44 may generate a cost curve that varies over time using the one or more cost factors, such as costs associated with maintenance events of a particular connected device (e.g., as indicated by cost data of connected device database 22), an estimated cost of replacement of the connected device, a geographical location in which the connected device is located, and/or any variety of other cost factors. Contribution rate unit 44 may determine a rate of contribution that is sufficient to satisfy the costs indicated by the cost curve.

In some examples, contribution rate unit 44 may determine a rate of contribution that varies over time. For example, contribution rate unit 44 may determine a rate of contribution that is relatively low when a connected device is new and increase the rate of contribution throughout the lifetime of the connected device, e.g., as general maintenance costs, repairs or replacement become more likely. In other examples, contribution rate unit 44 may determine a static rate of contribution that does not change throughout the lifetime of the connected device.

According to aspects of this disclosure, contribution rate unit 44 may determine the rate of contribution a single time or on a periodic basis. For example, contribution rate unit 44 may determine a rate of contribution for an estimated lifetime of the connected device at a time at which account association unit 38 associates the connected device with one of accounts 40.

In some examples, contribution rate unit 44 may also periodically determine (e.g., update) the rate of contribution one or more times over the lifetime of the connected device. For example, cost data from the same or comparable connected devices may be added to connected device database 22 in real-time or near real-time during operation of the connected devices. In another example, the user may move the connected device to a different geographical location or have a change in financial status. The changes to the cost factors may impact the above-described cost curve. Accordingly, contribution rate unit 44 may determine the one or more cost factors on a periodic basis and update the rate of contribution based on the updated cost factors.

According to aspects of this disclosure, contribution rate unit 44 may maintain separate contribution rates for repair of the connected device and replacement of the connected device. For example, contribution rate unit 44 may determine a first rate of contribution for maintaining a connected device based on the cost factors, as well as a second rate of contribution for replacing the connected device. Contribution rate unit 44 may determine the first rate of contribution and the second rate of contribution based on the same or different cost factors. For example, contribution rate unit 44 may determine the first rate of contribution for maintenance of the connected device based on the cost data and a geographical cost factor and may determine the second rate of contribution for replacement of the connected device based on an estimated cost of replacement and a financial status of the user (e.g., as indicated by financial data associated with the user).

Contribution rate unit 44 may output the rate of contribution. For example, contribution rate unit 44 may generate an electronic message to the user that indicates one or more suggested rates of contribution. In another example, contribution rate unit 44 may automatically transfer funds to one of financial accounts 40 associated with the connected device at the determined rate of contribution from another financial account of the user.

In the example of FIG. 2, device financing unit 14 also includes credit offer unit 46. According to aspects of this disclosure, credit offer unit 46 may generate a credit offer for a user of a connected device based on financial information about the user. For example, a financial services provider may seek to accelerate a purchase of a new connected device. Credit offer unit 46 may generate an offer for financing of a new connected device based on a variety of factors and send the offer to the user.

In some examples, credit offer unit 46 may generate a credit offer based on a status of a connected device. For example, credit offer unit 46 may receive data that indicates a failure of the connected device. In this example, credit offer unit 46 may generate a credit offer upon receiving an indication of the failure. In another example, credit offer unit 46 may determine that a particular component is prone to failure at a particular time. In this example, credit offer unit 46 may generate a credit offer near the particular time, along with a notification of the potential for failure. Hence, in the examples above, credit offer unit 46 may generate a credit offer based on the expected life and/or maintenance or repair history of a connected device.

In still another example, credit offer unit 46 may generate a credit offer based on an account balance of one of financial accounts 40. For example, financial account 40A associated with a particular connected device may have accrued four hundred dollars. In addition, an estimated cost of replacement for the particular connected device may be two thousand dollars. In this example, credit offer unit 46 may generate a credit offer based on the difference between the balance of financial account 40A and the estimated cost of replacement. In still other examples, credit offer unit 46 may generate a credit offer based on a financial status/health of a user and/or other credit offers that are available in the marketplace.

FIG. 3 is a conceptual diagram of a system for identifying a plurality of connected devices that are connected to a home network, in accordance with the techniques of this disclosure. The example of FIG. 3 includes computing device 12 having device financing unit 14, network 20, home network 60, connected devices 62A-62E (collectively, “connected devices 62”) and computing device 64 having device discovery unit 66.

Home network 60 may comprise a private network that is associated with a residence of a user. In some examples, home network 60 comprise one or more of a virtual private network (VPN), a LAN, a WLAN (e.g., a Wi-Fi network), or a wireless personal area network (WPAN) (e.g., a Bluetooth® network). Home network 60 may provide access to network 20 for connected devices 62. Connected devices 62 may include any of a wide variety of appliances (e.g., thermostats, refrigerators, microwaves, washing machines, dryers, ovens, toasters, lights, sprinkler systems, or the like) or other devices capable of connecting to home network 60.

According to aspects of this disclosure, computing device 64 may execute device discovery unit 66 to identify connected devices 62 so that device financing unit 14 may associate connected devices with a financial account. In one example, device discovery unit 66 may comprise a web-based interface associated with device financing unit 14. In this example, a user may log on to the web-based interface of a financial services provider using computing device 64. In other examples, device discovery unit 66 may be integrated with a mobile application that is capable of identifying connected devices 62 connected to home network 60. Device discovery unit 66 may poll home network 60 for connected devices 62.

As noted above, device financing unit 14 may maintain respective financial accounts for respective connected devices 62. In such examples, device financing unit 14 may perform a need-based transfer of funds between the respective financial accounts. For example, device financing unit 14 may identify a maintenance event for connected device 62E and determine an estimated cost of repair. Device financing unit 14 may also determine that the estimated cost of repair for connected device 62E exceeds a balance of the financial account associated with connected device 62E.

In the example above, device financing unit 14 may transfer funds from one or more financial accounts associated with one or more of connected devices 62A-62D based on the difference between the repair cost and the balance of the financial account associated with connected device 62E. Device financing unit 14 may then update a rate of contribution for the respective one or more other financial accounts based on an amount of the transferred funds, e.g., to account for the shortfall due to the transfer.

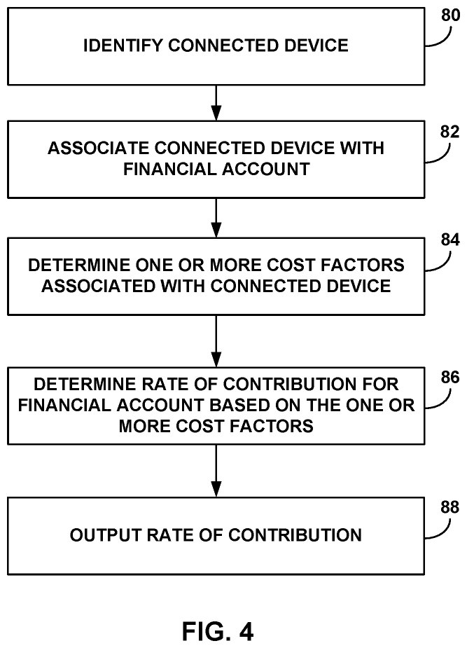

FIG. 4 is a flow diagram illustrating an example process for saving for maintenance, repair or replacement of a connected device, in accordance with the techniques of this disclosure. While described with respect to computing system 10 (FIGS. 1 and 2), it should be understood that the process described with respect to FIG. 4 may be carried out by a variety of computing devices.

In the example of FIG. 4, device financing unit 14 may identify a connected device, such as any of the connected devices described herein (80). In some examples, device financing unit 14 may determine a purchase of the connected device based on financial data associated with a user of the connected device. In such examples, device financing unit 14 may identify the connected device based on the determined purchase. In another example, device financing unit 14 may identify the connected device using an electronic application associated with the financial services provider upon connection of the connected device to a home network of the user (e.g., as described above with respect to the example of FIG. 3). In still other examples, device financing unit 14 may receive data from a user regarding the connected device (e.g., information identifying the connected device).

Device financing unit 14 may associate the connected device with a financial account designated for the connected device, where the financial account is being provided by a financial services provider (82). In some examples, device financing unit 14 may establish the financial account upon identifying the connected device. The financial account may be a sub-account of a pre-existing financial account provided by the financial services provider (e.g., a pre-existing checking or savings account). According to aspects of this disclosure, device financing unit 14 may generate a sub-account by transmitting an electronic offer to generate the sub-account to an electronic device associated with the user.

Device financing unit 14 may also determine one or more cost factors associated with the connected device (84). The one or more cost factors may be based on cost data that is sourced from a plurality of second connected devices that are comparable to the connected device and indicative of maintenance costs of the plurality of second connected devices. The one or more cost factors may additionally or alternatively include an initial cost of the connected device, an estimated cost of replacement, a geographical cost factor (e.g., a geographical cost associated with a geographical region in which the connected device is located), and/or a financial status cost factor.

In some examples, device financing unit 14 may periodically determine the one or more cost factors. For example, as described herein, cost data may be updated by connected devices in real-time or near real-time. Device financing unit 14 may update the one or more cost factors based on new data becoming available.

Device financing unit 14 may determine a rate of contribution for the financial account based on the one or more cost factors associated with the connected device (86). For example, device financing unit 14 may determine a rate of contribution that is sufficient to satisfy the costs associated with the maintaining or replacing the connected device, as indicated by the one or more cost factors. In some examples, device financing unit 14 may periodically determine/update the rate of contribution based on the one or more cost factors, e.g., due to changes in the one or more cost factors (e.g., updates to cost data, changes in geographical location, changes in financial status of the user, or the like). In some examples, device financing unit may increase the rate of contribution over a lifetime of the connected device, e.g., in anticipation of higher general maintenance, repair or replacement costs associated with an ageing device.

Device financing unit 14 may output the rate of contribution (88). For example, device financing unit 14 may generate an electronic message to the user that indicates the rate of contribution. In another example, device financing unit 14 may transfer funds to the financial account at the rate of contribution.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over a computer-readable medium as one or more instructions or code, and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry, as well as any combination of such components. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A computer-implemented method comprising:
identifying a purchase, based on both an analysis of a user's financial data from a financial services provider and interaction with one or more devices on a home network associated with the user, of a network-connected device having ongoing maintenance costs;
associating the network-connected device with a financial account of the user, the financial account being provided by the financial services provider, wherein associating the network-connected device with the financial account includes generating a financial account at the financial services provider as a repository of funds for contributions to a savings account for the network-connected device;
collecting usage data from the network-connected device;
determining, based on the usage data, one or more cost factors associated with the network-connected device, at least one of the one or more cost factors being further based on cost data that is sourced from a plurality of second network-connected devices that are comparable to the network-connected device and indicative of maintenance costs associated with the plurality of second network-connected devices;
determining a rate of contribution for the financial account based on the usage data and the one or more cost factors associated with the network-connected device;
outputting the rate of contribution;
determining, based on the usage data received from the network-connected device and the cost data that is sourced from the plurality of second network-connected devices, that a component of the network-connected device is prone to failure, wherein determining that the component of the network-connected device is prone to failure includes determining that the network-connected device has been used for a period of time during which a corresponding component of the second network-connected devices has failed;
responsive to determining that the network-connected device is prone to failure, performing an analysis, based on an account balance of the financial account, to identify a financing arrangement for replacement of the network-connected device; and
outputting a signal to a mobile device associated with the user to cause the mobile device to present results of the analysis, wherein the results of the analysis includes a notification relating to failure of the network-connected device, and further includes an offer to establish the identified financing arrangement for replacement of the network-connected device.

2. The method of claim 1, wherein determining the one or more cost factors comprises periodically determining the one or more cost factors, and wherein determining the rate of contribution comprises periodically determining the rate of contribution based on the one or more cost factors.

3. The method of claim 2, wherein periodically determining the rate of contribution comprises increasing the rate of contribution over a lifetime of the network-connected device.

4. The method of claim 1, further comprising sourcing the cost data from the plurality of second network-connected devices in real-time or near real-time.

5. The method of claim 1, wherein determining the one or more cost factors comprises determining a geographical cost associated with a geographical region in which the network-connected device is located.

6. The method of claim 5, wherein determining the geographical cost comprises determining an availability of maintenance technicians for the network-connected device in the geographical region.

7. The method of claim 1, wherein determining the one or more cost factors comprises determining an initial purchase price of the network-connected device.

8. The method of claim 1, wherein determining the rate of contribution further comprises determining the rate of contribution based on financial data associated with the user that is maintained by the financial services provider.

9. The method of claim 1, wherein the rate of contribution comprises a first rate of contribution for maintaining the network-connected device, the method further comprising determining a second rate of contribution for replacing the network-connected device.

10. The method of claim 9, wherein determining the second rate of contribution comprises determining the second rate of contribution based on at least one of a purchase price of the network-connected device or financial data associated with the user that is maintained by the financial services provider.

11. The method of claim 9, further comprising increasing the second rate of contribution based on the financial data indicating an improving financial status of the user.

12. The method of claim 1, wherein the financial account is a sub-account of a preexisting financial account, the method further comprising:
generating the sub-account based on the identification of the network-connected device; and
wherein associating the network-connected device with the financial account comprises associating the network-connected device with the generated sub-account.

13. (canceled)

14. The method of claim 12, wherein identifying the network-connected device comprises identifying the network-connected device using an electronic application associated with the financial services provider upon connection to the home network of the user.

15. The method of claim 12, wherein generating the sub-account comprises transmitting an electronic offer to generate the sub-account to the mobile device associated with the user.

16. The method of claim 1, wherein outputting the rate of contribution comprises generating an electronic message to the user that indicates the rate of contribution.

17. The method of claim 1, wherein outputting the rate of contribution comprises transferring funds to the financial account at the rate of contribution.

18. The method of claim 1, wherein the offer to establish the identified financing arrangement includes a credit offer for the user based on the account balance of the financial account.

19. The method of claim 18, wherein generating the credit offer further comprises generating the credit offer based on an estimated cost of replacement for the network-connected device, financial data associated with the user that is maintained by the financial services provider, an expected lifetime of the network-connected device, or credit offers available from another financial services provider.

20. The method of claim 1, further comprising:
associating one or more other network-connected devices of the user with respective one or more other financial accounts of the user;
determining that a repair cost for the network-connected device exceeds a balance of the financial account;
transferring funds from one or more of the respective one or more other financial accounts to the financial account based on the difference between the repair cost and the balance of the financial account.

21. The method of claim 20, further comprising updating a rate of contribution for the respective one or more other financial accounts based on an amount of the transferred funds.

22. A non-transitory computer-readable medium having instructions stored thereon that, when executed, cause one or more processors to:
identify a purchase, based on both an analysis of a user's financial data from a financial services provider and interaction with one or more devices on a home network associated with the user, of a network-connected device having ongoing maintenance costs;
associate the network-connected device with a financial account of the user, the financial account being provided by a financial services provider, wherein associating the network-connected device with the financial account includes generating a financial account at the financial services provider as a repository of funds for contributions to a savings account for the network-connected device;
collect usage data from the network-connected device;
determine, based on the usage data, one or more cost factors associated with the network-connected device, at least one of the one or more cost factors being further based on cost data that is sourced from a plurality of second network-connected devices that are comparable to the network-connected device and that is indicative of maintenance costs of the plurality of second network-connected devices;
determine a rate of contribution for the financial account based on the usage data and the one or more cost factors associated with the network-connected device;
output the rate of contribution;
determine, based on the usage data received from the network-connected device and the cost data that is sourced from the plurality of second network-connected devices, that a component of the network-connected device is prone to failure, wherein to determine that the component of the network-connected device is prone to failure the one or more processors determine the network-connected device has been used for a period of time during which a corresponding component of the second network-connected devices has failed;
responsive to determining that the network-connected device is prone to failure, perform an analysis, based on an account balance of the financial account, to identify a financing arrangement for replacement of the network-connected device; and
output a signal to a mobile device associated with the user to cause the mobile device to present results of the analysis, wherein the results of the analysis includes a notification relating to failure of the network-connected device, and further includes an offer to establish the identified financing arrangement for replacement of the network-connected device.

23. A device comprising:
a memory configured to store data associated with a financial account of a user; and
one or more processors in communication with the memory, the one or more processors configured to:
identify a purchase, based on both an analysis of a user's financial data from a financial services provider and interaction with one or more devices on a home network associated with the user, of a network-connected device having ongoing maintenance costs;
associate the network-connected device with the financial account of the user, wherein associating the network-connected device with the financial account includes generating a financial account at the financial services provider as a repository of funds for contributions to a savings account for the network-connected device;
collect usage data from the network-connected device;
determine, based on the usage data, one or more cost factors associated with the network-connected device, at least one of the one or more cost factors being further based on cost data that is sourced from a plurality of second network-connected devices that are comparable to the network-connected device and that is indicative of maintenance costs of the plurality of second network-connected devices;
determine a rate of contribution for the financial account based on the usage data and the one or more cost factors associated with the network-connected device;
output the rate of contribution;
determine, based on the usage data received from the network-connected device and the cost data that is sourced from the plurality of second network-connected devices, that a component of the network-connected device is prone to failure, wherein to determine that the component of the network-connected device is prone to failure the one or more processors determine that the network-connected device has been used for a period of time during which a corresponding component of the second network-connected devices has failed;
responsive to determining that the network-connected device is prone to failure, perform an analysis, based on an account balance of the financial account, to identify a financing arrangement for replacement of the network device; and
output a signal to a mobile device associated with the user to cause the electronic device to present results of the analysis, wherein the results of the analysis includes a notification relating to failure of the network-connected device, and further includes an offer to establish the identified financing arrangement for replacement of the network-connected device.
